(19) United States
(12) Patent Application Publication
(10) Pub. No.: US 2022/0332491 A1
(43) Pub. Date: Oct. 20, 2022

(54) MOISTURE DEGRADED PACKAGING SEAL

(71) Applicant: The Hillshire Brands Company, Chicago, IL (US)

(72) Inventors: Benjamin M. Cichowski, Naperville, IL (US); Jeffrey Anthony Czarny, Schaumburg, IL (US)

(73) Assignee: The Hillshire Brands Company, Chicago, IL (US)

(21) Appl. No.: 17/853,339

(22) Filed: Jun. 29, 2022

Related U.S. Application Data
(63) Continuation of application No. 15/785,194, filed on Oct. 16, 2017.
Application No. 15/785,194 is a continuation of application No. 14/022,137, filed on Sep. 9, 2013, now abandoned.
Application No. 14/022,137 is a continuation of application No. 12/943,769, filed on Nov. 10, 2010, now abandoned.
Application No. 12/943,769 is a continuation-in-part of application No. 12/116,109, filed on May 6, 2008, now abandoned.
(60) Provisional application No. 60/928,547, filed on May 10, 2007.

(51) Int. Cl. B65D 81/34; B65D 75/36; B65D 81/26; H05B 6/64; H05B 6/80

(52) U.S. Cl. CPC B65D 81/3446; B65D 75/366; B65D 81/264; B65D 81/267; H05B 6/6479; H05B 6/80

(57) ABSTRACT

A packaged food product can include: a package and food disposed within the package. The package includes an inflatable first sheet comprising polymer, and a generally flat second sheet comprising paper material and polymer. The first sheet and the second sheet can be melted together to form a peripheral seal that includes paper material from the second sheet suspended within a melt between the first sheet polymer and the second sheet polymer. The food can be disposed on the second sheet and in direct physical contact with the paper material.

### CROSS-REFERENCE TO RELATED APPLICATIONS

The present application is a continuation of U.S. patent application Ser. No. 15/785,194 (filed on 16 Oct. 2017), which is a continuation of U.S. patent application Ser. No. 14/022,137 (filed on 9 Sep. 2013), which is a continuation of U.S. patent application Ser. No. 12/943,769 (filed on 10 Nov. 2010), which is a continuation-in-part of U.S. patent application Ser. No. 12/116,109 (filed on 6 May 2008), which claims the benefit of U.S. Provisional App. No. 60/928,547 (filed on 10 May 2007). The above applications and U.S. Pub. No.2014/0010927 to Cichowski et. al. are each hereby incorporated by reference herein.

### BACKGROUND

The present disclosure relates generally to the field of packagings for food products, and more specifically, to packagings for food products that provide a more convenient means for preparing (e.g., microwave cooking, etc.) frozen or refrigerated food products for consumption by consumers.

There are many challenges associated with providing consumers with an easy and effective means for preparing food products using microwave ovens. Some of the long unresolved problems associated with microwave cooking include inconveniences to consumers, dryness/sogginess of food products, and uneven cooking of food products, among others.

For example, many packaged food products require users to open a packaging, remove a food product, wrap the food product in a separate covering such as paper towel, etc., and then place the wrapped food product into the microwave. Such additional steps take considerable time and are inconvenient for consumers. Further, food products often release moisture during microwave cooking. Without proper control of the released moisture, the resulting food product may be soggy, or alternatively, overly dry, and undesirable for consumption. Further yet, many food products are unevenly heated when prepared in a microwave oven, due to improper control of moisture and/or other factors.

It would be advantageous to provide an improved packaged food product that addresses and/or overcomes one or more of these challenges by providing a user-friendly, easy-to-use, one-step packaged food product that is also aesthetically pleasing in appearance. As such, various embodiments disclosed herein provide a packaged food product that may be microwaveably cooked in a “one-step” fashion, and that includes, among other features, venting and moisture absorption features to control the humidity within the packaging and provide for an optimal moisture content of multi-component food products.

### SUMMARY

A packaged food product can include: a package and food disposed within the package. The package can include: (a) an inflatable first sheet comprising polymer, and (b) a generally flat second sheet comprising paper material and polymer. The first sheet and the second sheet can be melted together to form a peripheral seal comprising: paper material from the second sheet suspended within a melt between the first sheet polymer and the second sheet polymer. The food can be disposed on the second sheet and in direct physical contact with the paper material.

A method can include heating a packaged food product in a microwave at least until: moisture from the food turns into stream; the steam inflates a cover and thereby releases the cover from a top of the food and sides of the food to define a steam dome between the food and the cover; condensate from the steam infiltrates and breaches a peripheral seal; steam escapes from the steam dome into the microwave through the breached peripheral seal.

A packaged food product can include food and a peripheral seal comprising paper material suspended within a polymer melt. A method can include providing the packaged food product. The method can include heating the packaged food product in a microwave.

### BRIEF DESCRIPTION OF DRAWINGS

FIG. 1 is a perspective view of a packaged food product according to an exemplary embodiment.

FIG. 2 is an exploded perspective view of the packaged food product of FIG. 1 according to an exemplary embodiment.

FIG. 3 is an exploded view of a film used in the packaged food product of FIG. 1 according to an exemplary embodiment.

FIG. 4 is a cross-section side view of the packaged food product of FIG. 1 according to an exemplary embodiment.

FIG. 5 is a perspective view of a packaged food product according to an alternative exemplary embodiment.

FIG. 6 is an exploded perspective view of the packaged food product of FIG. 5 according to an exemplary embodiment.

FIG. 7 is an exploded view of a film used in the packaged food product of FIG. 5 according to an exemplary embodiment.

FIG. 8 is a cross-section side view of the packaged food product of FIG. 5 according to an exemplary embodiment.

### DETAILED DESCRIPTION OF EXEMPLARY EMBODIMENTS

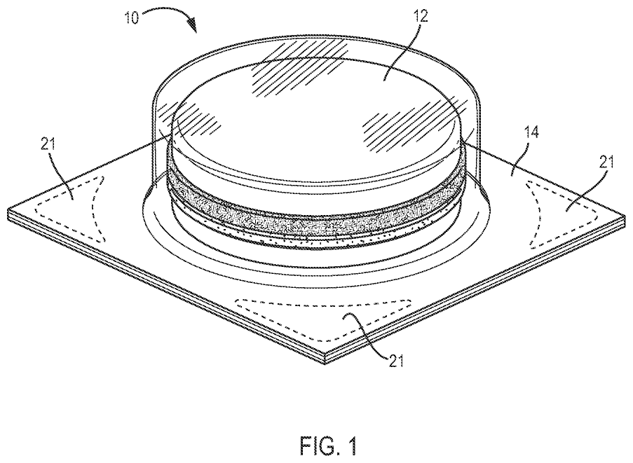

Referring to FIG. 1, a packaged food product 10 (e.g., a breakfast product, a snack product, etc.) is shown according to an exemplary embodiment. Packaged food product 10 may be any of a variety of packaged food products, including, but not limited to, breakfast items such as breakfast sandwiches, etc., lunch items such as lunch sandwiches, etc., dinner items, snack portions, and the like. As shown in FIG. 1, packaged food product 10 includes a food product 12 provided within the interior of packaging 14. Food product 12 may naturally contain moisture that is released when food product 12 is heated as a result of undergoing a cooking process (e.g., microwave cooking, etc.).

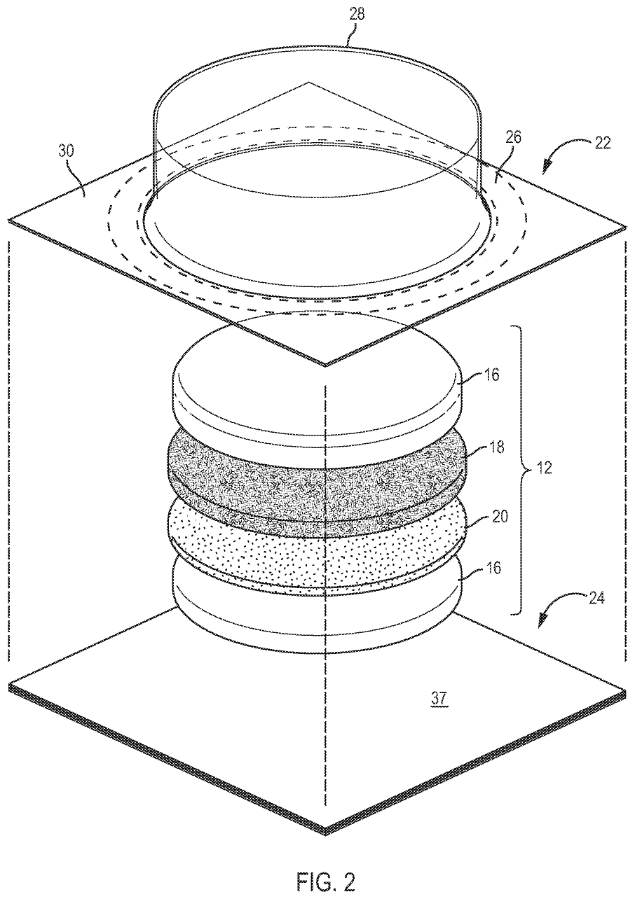

Referring to FIGS. 1 and 2, according to an exemplary embodiment, food product 12 is a multi-component food product and includes a plurality of physically separate food components shown as components 16, 18, and 20. For example, in some embodiments, food product 12 may be a breakfast sandwich, such that component 16 may be one or more pieces of biscuit, bun, or similar bread item, component 18 may be a sausage, bacon, or other meat item, and component 20 may be a cheese, sauce, or other topping item. According to various other embodiments, food product 12 may be any of a wide variety of other products, including a lunch sandwich, a snack item, etc. As such, components 16, 18, and 20 may be any of a variety of different components. According to yet other embodiments, food product 12 may include fewer or more components than those shown in FIG. 2 (e.g., a single food component, two food components, four or more food components, etc.)

Further, while in some embodiments food product 12 may be intended to be sold to consumers in a frozen state, in other embodiments food product 12 may be intended to be sold to consumers in a refrigerated or other state. Thus, the embodiments herein may extend to preparing packaged food products having food products in either a frozen or refrigerated state.

According to one embodiment, packaging 14 includes a first film 22 (e.g., a top film or portion, a formed portion, a forming film, etc.) and a second film 24 (e.g., a second film or portion, a flat portion, a non-forming film, etc.). First and/or second films 22, 24 may be formed using any suitable process, including a vacuum-forming process, a flow-wrapping process, etc. First film 22 includes a recess 28 (e.g., a pocket, receptacle, formed portion, etc.) and a generally flat portion 30 extending about recess 28. As discussed in greater detail below, in one embodiment, recess 28 is sized to provide a space, or gap 42 (e.g., “a steam dome”) about food product 12 when food product 12 is heated in a microwave oven. First film 22 may be made from a semi-rigid film material, such as polyesters (e.g., amorphous polyethylene terephthalate (APET), polyethylene terephthalate (PETG), etc.), polyvinyl chloride (PVC) polypropylene (PP) or reduced density PP, high impact polystyrene, and the like. As such, first film 22 may have sufficient rigidity to support food product 12 after heating and during consumption of food product 12 (e.g., after removal of second film 24 from first film 22). In other embodiments, first film 22 may be made from a variety of other materials, including various polymer or other materials.

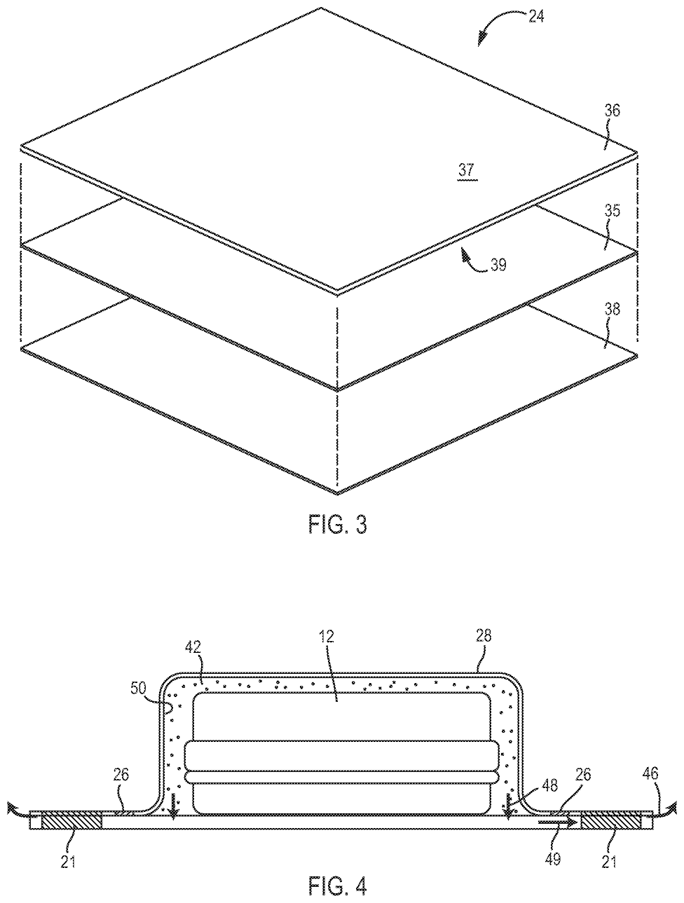

Referring now to FIGS. 2-4, second film 24 is a generally flat film. According to an exemplary embodiment, second film 24 includes an absorbent layer configured to absorb at least a portion of the moisture released from food product 12 during heating of food product 12 (e.g., such that liquids, etc. may travel along a path such as that indicated by arrows 48, 49 shown in FIG. 4). For example, as shown in FIG. 3, second film 24 may include an absorbent layer 36 (e.g., a paper material, etc.). In one embodiment, second film 24 may be a substantially rigid film. In other embodiments, part or all of second film 24 may be a semi-rigid or flexible film.

Referring to FIG. 3, according to an exemplary embodiment, second film 24 is a laminated film having different layers of material laminated together. For example, as shown in FIG. 3, second film 24 may include absorbent layer 36 (e.g., a first layer, an absorbent layer, a paper-based layer, etc.), a middle layer 35 (e.g., an adhesive layer, a second layer, etc.) and an outer layer 38 (e.g., a third layer, a plastic layer, an outer barrier, etc.). Layers 35, 36, 38 may be laminated (e.g., bonded, sealed, adhered, coupled, etc.) together using any suitable methods. According to an exemplary embodiment, absorbent layer 36 includes an inner-facing cellulose side 37 (e.g., a paper-based side) and an outer-facing polypropylene side 39 (e.g., a polymer-based side). Middle layer 35 may be a polyethylene adhesive or similar material. Outer layer 38 may be a thermoplastic polymer such as oriented polyethylene terephthalate (e.g., a 48 gauge OPET material, etc.) or similar material.

According to one embodiment, first film 22 and second film 24 are sealed by way of melting a portion of absorbent layer 36, for example, during a heat sealing process. For example, absorbent layer 36 may include an inner-facing paper-based layer that also includes polypropylene fibers. As such, first and second films 22, 24 may be heat sealed together (e.g., at seal portion 26) such that the polypropylene fibers present in absorbent layer 36 at least partially melt during the heat sealing process, thereby bonding first and second films 22, 24 together. In sealing films 22 and 24, the seal is formed through the paper-based layer of absorbent layer 36 and with the polypropylene material. The strength of the seal may in some embodiments be varied by changing the paper content of the absorbent layer, as paper fibers tend to degrade the strength of the seal.

According to one embodiment, absorbent layer 36 may be positioned such that absorbent layer 36 faces food product 12. According to other embodiments, one or both of layers 35, 38 may be omitted from second film 24, such that absorbent layer 36 may act as both an inner and/or outer layer for second film 24. Absorbent layer 36 is configured to absorb moisture (e.g., heated water vapor, steam, liquids such as water, oils, grease, etc.) released from food product 12 during heating (e.g., exposure to microwave energy) of food product 12. As such, absorbent layer 36 acts to control the moisture content of food product 12 and prevent food product 12 from becoming too soggy (due to excessive moisture) or too dry (due to lack of moisture). In one embodiment, absorbent layer 36 may be or include an absorbent paper material, such, as cellulose. In other embodiments, absorbent layer 36 may be or include a variety of other materials.

According to one embodiment, outer layer 38 is provided to an opposite side of absorbent layer 36 from food product 12. Outer layer 38 acts as an outer barrier for packaging 14 and prevents unwanted moisture, gases, and other products from entering/exiting packaging 14. In one embodiment, outer layer 38 is or includes a plastic material, such as 48 gauge OPET. In other embodiments, outer layer 38 may be or include a variety of other materials.

Referring further to FIGS. 1-4, according to an exemplary embodiment, first film 22 is sealed (e.g., releasably sealed and/or resealably sealed, coupled, etc.) to second film 24 along a seal portion 26 (see FIGS. 2 and 4) such that after heating of packaged food product 10, second film 24 may be removed from first film 22, providing consumers access to food product 12. Food product 12 is contained with the interior of packaging 14 formed by first and second films 22, 24. Seal portion 26 may include any of a number of seal types, including heat sealing, adhesives, ultrasonic welding, and the like. In one embodiment, some or all of seal 26 is a non-hermetic heat seal that permits passage of fluids (e.g., steam, moisture, etc.) through seal 26. In some embodiments, seal portion 26 may extend around the entire periphery of recess 28 of first film 22. As discussed below, certain portions of seal portion 26 may provide a self-venting feature for packaged food product 10 to provide for the release of steam during heating of food product 12.

Referring now to FIG. 4, according to an exemplary embodiment, packaging 14 is configured to provide a “steam dome” around portions of food product 12 during heating of food product 12. For example, as shown in FIG. 4, a steam dome shown as gap or space 42 is provided between food product 12 and recess 28 of first film 22. As food product 12 is heated, steam is generated and “inflates” first film 22. Space 42 provides an area through which this steam is able to travel and continue to provide heat to food product 12 (e.g., acting as an insulator to keep the food product heated longer by conducting heat) and to provide for “steam-assisted cooking,” or “steam-conductive heating.” This may serve to equilibrate the moisture within packaging 14 and ensure faster and more even cooking of food product 12 relative to more traditional means of microwave cooking, where steam is simply released into the interior of the microwave oven. Further, providing space 42 also permits moisture to uniformly re-enter food product 12 to avoid over-drying of food product 12, resulting in an optimal moisture content food product 12.

According to some embodiments, an anti-fog layer feature or layer 50 (e.g., an anti-fog treatment or feature, etc.) may be provided as part of or on the inner surface of first film 22. Anti-fog layer 50 may be a separate layer of material, or may be provided as an integral part of first film 22. For example, in some embodiments, anti-fog material may be added to a resin (e.g., as resin chips or the like) used to make one or more films of packaging 14. Providing an anti-fog surface on first film 22 eliminates and/or prevents the formation of water beads or droplets that may otherwise form on first film 22 during heating of food product 12.

Furthermore, anti-fog layer 50 resists fogging (clouding, discoloring, etc.) of the films due to extreme or sudden temperature changes. An anti-fog surface also maintains an aesthetically appealing visual appearance to packaged food product 10 prior to, during, and after heating of packaged food product 10, as the packaging does not “fog up” (e.g., the packaging remains substantially transparent if a transparent packaging material is used). According to various alternative embodiments, an anti-fog treatment may be provided on or as a part of one or both of first film 22 and second film 24. In one embodiment, as water condenses on the films, the anti-fog treatment causes the water to run (e.g., drain, flow, wick, etc.) toward absorbent layer 36, where it may remain and/or be regenerated back into steam. As a result of the anti-fog treatment, rather than water beads or droplets forming, the anti-fog treatment reduces the surfaces tension of the film (i.e., “wetting” the film) such that only a fine layer of water forms (e.g., a “non-scattering” film of water) and runs down the sides of the film.

As indicated earlier, one or more vent portions may be provided as part of packaging 14. For example, seal portion 26 may provide a self-venting feature for packaging 14, such that one or more portions of seal portion 26 (e.g., the interface between first and second films 22, 24) may be configured to permit a desired amount of steam or moisture to escape from the interior of packaging 14 during heating of food product 12 (e.g., along a path indicated by arrow 46 shown in FIG. 4). In some embodiments, one or more portions of seal portion 26 may be “weakened” to provide venting of steam and/or moisture. Furthermore, first film 22 may be shaped or sized to direct moisture to weakened portions of seal portion 26. For example, first film 22 may include one or more flutes (e.g., corrugations, etc.) or other features to direct moisture to specific portions of seal portion 26.

In yet other embodiments, packaging 14 may be configured such that a user may “peel back” a portion of first film 22 from second film 24 (e.g., using an “easy peel” feature) to provide an opening through which steam may escape from the interior of packaging 14 during heating of food product 12. For example, due to the presence of paper fibers (e.g., non-woven, porous paper) in the films, seal portion 26 may be weakened as the moisture (e.g., steam) escaping from the package reduces the tensile strength of the paper fibers. According to yet further embodiments, one or more vent portions may be configured to provide venting only upon heating of packaged food product 10 (e.g., such that the vent portions are otherwise substantially impermeable to liquids and/or gases).

In some embodiments, excess moisture may be directed through specific portions of seal portion 26 to areas of packaging 14 outside of seal portion 26. For example, weakened portions or channels may be used to direct moisture to areas 21 of packaging 14 to take advantage of the absorbency of those areas that may otherwise not by utilized. Weakened portions of seal 26 may be provided in a variety of ways, including narrowing the “width” of the seal and/or reducing the “thickness” of the seal. Other ways of providing weakened areas of seal 26 may be utilized according to various other embodiments. For example, various parameters of packaging machinery (e.g., pressure, temperature, dwell time, etc.) may be varied in order to provide a seal of a desired strength (e.g., a “controllable seal” formed through “fiber intervention,” where the presence of papers fibers in the seal area can be increased or decreased to control the strength of the seal).

As shown in FIG. 1, areas 21 may be provided in one or more of the “corners” of packaging 14. According to various alternative embodiments, the location and number of areas 21 may be varied to suit a particular packaging configuration (e.g., variations in size, shape, etc.). In some embodiments, a scented material may be provided in areas 21, and the scented material may be activated by heat and/or moisture, such that as the food product is prepared and moisture and/or heat travels to areas 21, a scent (e.g., a fresh bread scent, a sage sausage scent, etc.) may be activated and/or released. In one embodiment, the scented material is provided in one or more absorbent layers of the packaging, although the scented material may be provided using different methods according various other embodiments. As indicated above, the scented material may release a scent (e.g., a fresh bread scent) that is normally associated by consumers with the food product (e.g., a bread food product) being prepared, to enhance the consumer experience. The scent, may be activated by the contact with the moisture, the heat, air, or the like or combinations thereof.

In combination with the absorbent features of second film 24, the venting features of packaging 14 are intended to control the humidity and/or temperature and equilibrate the moisture content (e.g., maintain a consistent, even, or desired level of moisture) within the interior of packaging 14 during heating of food product 12 such that, for example, the humidity level within the interior of packaging 14 remains at or below a predetermined level during the dynamic heating cycle of food product 12. The absorbent layer acts as a “buffer” or “moisture sink” to control the amount of steam/moisture within the packaging. For example, one or more venting features of packaging 14 may be configured to “delay” any venting of steam or moisture until a predetermined temperature, pressure, or moisture content is reached within the interior of packaging 14. This may help to provide for faster cooking cycles and ensure a proper moisture content for food product 12 and avoid an over-dry or soggy food product.

In order to prepare the packaged food product of the present disclosure, a consumer may first simply place the packaged food product in a microwave oven, with the “flat” portion (e.g., second film 24) facing downward (to permit formation of the “stream dome”). The consumer may then heat the packaged food product in the microwave oven for an appropriate amount of time (e.g., 1 minute, 2 minutes, etc.). During heating, steam may be released from the food product and form a “steam dome” around the exterior of the food product (e.g., inflating first film 22 to define space 42). A portion of the moisture from the steam may be reabsorbed by the food product, a portion may be vented to the outside environment, and a portion may be absorbed by the absorbent layer of the packaging. Additional moisture (e.g., liquids such as oils, grease, etc.) released by the food product may further be absorbed by the absorbent layer of the packaging. The food product construction; the moisture content of the food product; the size of space 42; the type, amount of, and performance of the absorbent layer; and the size, location, and performance of the vent portions are balanced to provide the proper level of moisture within packaging 14 during preparation of food product 12. Upon completion of the heating cycle, the consumer may simply remove the packaged food product from the microwave oven, remove the flat film (e.g. second film 24) and consume the food product directly from the remaining packaging. If desired, a portion of the packaging may be used to hold the food product during consumption.

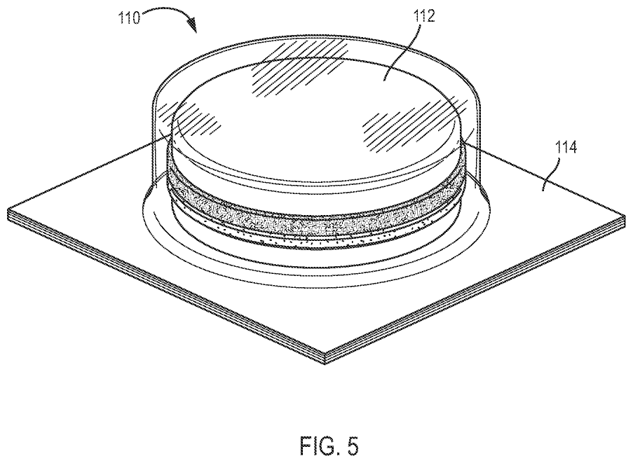

Referring now to FIGS. 5-8, a packaged food product 110 (e.g., a breakfast product, a snack product, etc.) is shown according to an alternative exemplary embodiment. Packaged food product 110 may be similar to packaged food product 10 and include any of a variety of packaged food products, including, but not limited to, breakfast items such as breakfast sandwiches, etc., lunch items such as lunch sandwiches, etc., dinner items, snack portions, and the like. As shown in FIG. 5, packaged food product 110 includes a food product 112 provided within the interior of packaging 114.

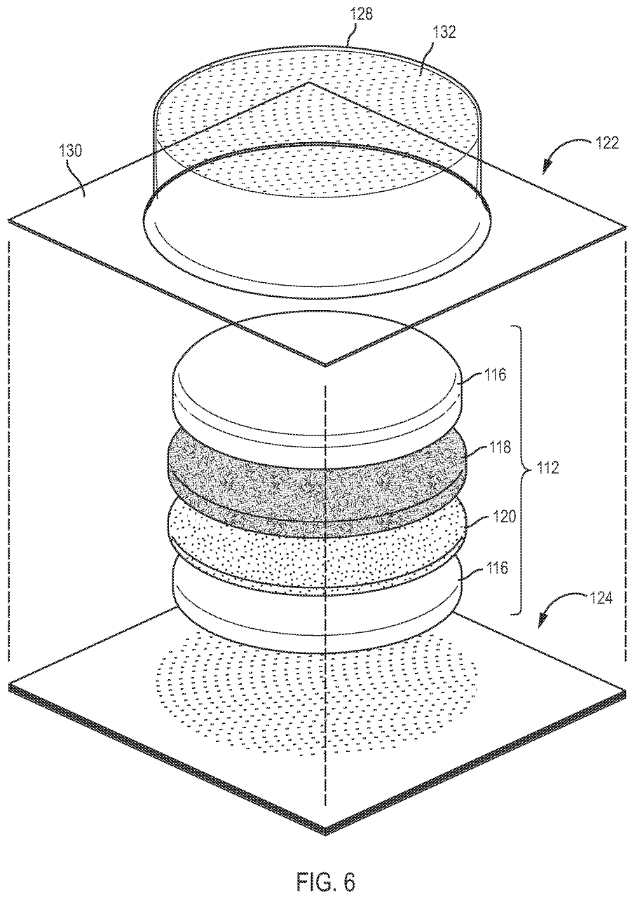

Referring to FIGS. 5 and 6, according to an exemplary embodiment, food product 112 is a multi-component food product and includes a plurality of physically separate food components shown as components 116, 118, and 120. For example, in some embodiments, food product 112 may be a breakfast sandwich, such that component 116 may be one or more pieces of biscuit, bun, or similar bread item, component 118 may be a sausage, bacon, or other meat item, and component 120 may be a cheese, sauce, or other topping item.

According to various other embodiments, food product 112 may be any of a wide variety of other products, including a lunch sandwich, a snack, item, etc. As such, components 116, 118, and 120 may be any of a variety of different components. According to yet other embodiments, food product 112 may include fewer or more components than those shown in FIG. 6 (e.g., a single food component, two food components, four or more food components, etc.)

Further, while in some embodiments food product 112 may be intended to be sold to consumers in a frozen state, in other embodiments food product 112 may be intended to be sold to consumers in a refrigerated or other state. Thus, the embodiments herein may extend to preparing packaged food products having food products in either a frozen or refrigerated state.

According to one embodiment, packaging 140 includes a first film 122 (e.g., a top film or portion, a formed portion, etc.) and a second film 124 (e.g., a second film or portion, a flat portion, etc.). First and second films 122, 124 may be formed using any suitable process, including a vacuum-forming process, a flow-wrapping process, etc. First film 122 includes a recess 128 (e.g., a pocket, receptacle, formed portion, etc.) and a generally flat portion 130 extending about recess 128. As discussed in greater detail below, in one embodiment, recess 128 is sized to provide a space, or gap 142 (e.g., “a steam dome”) about food product 112 when food product 112 is heated in a microwave oven. First film 122 may be made from a semi-rigid film material, such as polyesters (e.g., amorphous polyethylene terephthalate (APET), polyethylene terephthalate (PETG), etc.), polyvinyl chloride (PVC), polypropylene (PP) or reduced density PP, high impact polystyrene, and the like. As such, first film 122 may have sufficient rigidity to support food product 112 after heating and during consumption of food product 112 (e.g., after removal of second film 124 from first film 122). In other embodiments, first film 122 may be made from a variety of other materials, including various polymer or other materials.

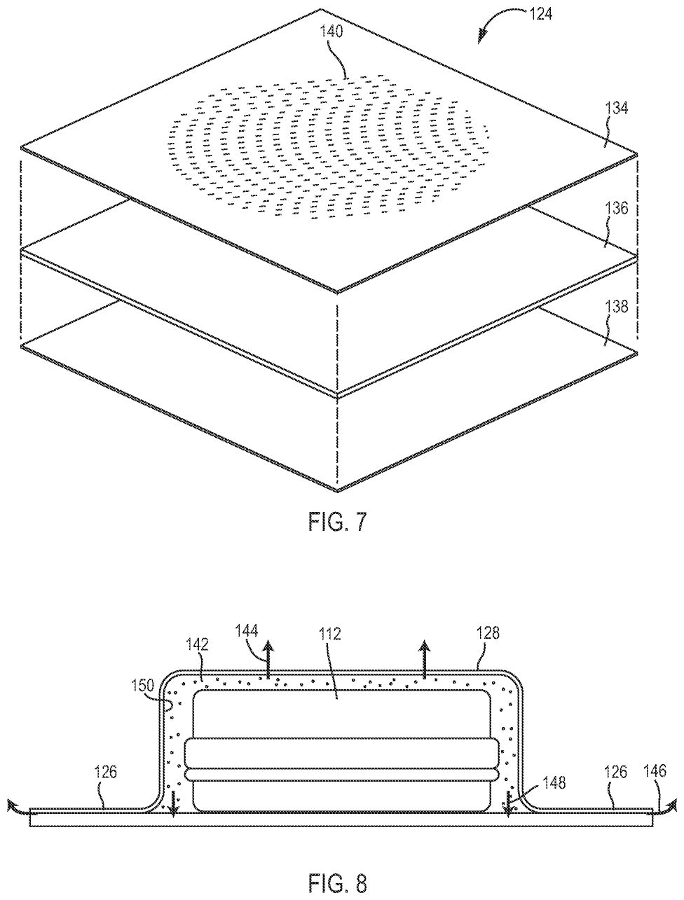

Referring now to FIGS. 6-8, second film 124 is a generally flat film. According to an exemplary embodiment, second film 124 includes an absorbent layer configured to absorb at least a portion of the moisture released from food product 112 during heating of food product 112 (e.g., such that liquids, etc. may travel along a path such as that indicated by arrow 148 shown in FIG. 8). For example, as shown in FIG. 7, second film 124 may include an absorbent layer 136 (e.g., a paper material, etc.). In one embodiment, second film 124 may be a substantially rigid film. In other embodiments, part or all of second film 124 may be a semi-rigid or flexible film.

Referring to FIG. 7, according to an exemplary embodiment, second film 124 is a laminated film having different layers of material laminated together. For example, as shown in FIG. 7, second film 124 may include an inner layer 134 (e.g., a first layer, a plastic layer, a perforated layer, etc.), absorbent layer 136 (e.g., a second layer, an absorbent layer, a paper-based layer, etc.), and an outer layer 138 (e.g., a third layer, a plastic layer, an outer barrier, etc.). Layers 134, 136, 138 may be laminated (e.g., bonded, sealed, adhered, coupled, etc.) together using any suitable methods.

According to one embodiment, inner layer 134 is positioned such that inner layer 134 faces food product 112. In some embodiments, inner layer 134 may include one or more perforations 140 (e.g., slits, slots, apertures, micro-perforations, etc.) that are configured to permit moisture released from food product 112 during heating of food product 112 to travel through inner layer 134 to be absorbed by absorbent layer 136. Perforations 140 may be provided in any desired configuration, with any of a variety of sizes, shapes, etc., and the configuration of perforations 140 may be based on the food product to be contained within packaging 140. In one embodiment, inner layer 134 may be made from a food-grade plastic material, such as polyethylene (PE). In other embodiments, inner layer 134 may be or include a variety of other materials.

According to one embodiment, absorbent layer 136 may be provided between inner layer 134 and outer layer 138. According to other embodiments, one or both of layers 134, 138 may be omitted from second film 124, such that absorbent, layer 136 may also act as an inner and/or outer layer for second film 124. Absorbent layer 136 is configured to absorb moisture (e.g., liquids such as water, oils, grease, etc.) released from food product 112 during heating of food product 112. As such, absorbent layer 136 acts to control the moisture content of food product 112 and prevent food product 112 from becoming too soggy (due to excessive moisture) or too dry (due to a lack of moisture). In one embodiment, absorbent layer 136 may be or include an absorbent paper material, such as cellulose. In other embodiments, absorbent layer 136 may be or include a variety of other materials. The amount of moisture absorbed by absorbent layer 136 may be controlled at least in part by controlling the configuration (number, size, spacing, etc.) of perforations 140 in inner layer 134.

According to one embodiment, outer layer 138 is provided to an opposite side of absorbent layer 136 from inner layer 134. Outer layer 138 acts as an outer barrier for packaging 114 and prevents unwanted moisture, gases, and other products from entering/exiting packaging 114. In one embodiment, outer layer 138 is or includes a plastic material, such as 48 gauge OPET. In other embodiments, outer layer 138 may be or include a variety of other materials.

Referring further to FIGS. 5-8, according to an exemplary embodiment, first film 122 is sealed (e.g., releasably sealed and/or resealably sealed, coupled, etc.) to second film 124 along a seal portion 126 (see FIGS. 6 and 8) such that after heating of packaged food product 110, second film 124 may be removed from first film 122, providing consumers access to food product 112. Food product 112 is contained with the interior of packaging 114 formed by first and second films 122, 124. Seal portion 126 may include any of a number of seal types, including heat sealing, adhesives, ultrasonic welding, and the like. In some embodiments, seal portion 126 may extend around the entire periphery of recess 128 of first film 122. As discussed below, certain portions of seal portion 126 may provide a self-venting feature for packaged food product 110 to provide for the release of steam during heating of food product 112.

Referring now to FIG. 8, according to an exemplary embodiment, packaging 114 is configured to provide a “steam dome” around portions of food product 112 during heating of food product 112. For example, as shown in FIG. 8, a steam dome shown as gap or space 142 is provided between food product 112 and recess 128 of first film 122. As food product 112 is heated, steam is generated. Space 142 provides an area through which this steam is able to travel and continue to provide heat to food product 112. This may serve to equilibrate the moisture within packaging 114 and ensure faster and more even cooking of food product 112 relative to more traditional means of microwave cooking, where steam is simply released into the interior of the microwave oven. Further, providing space 142 also permits moisture to uniformly re-enter food product 112 to avoid over-drying of food product 112, resulting in an optimal moisture content food product 112.

According to some embodiments, an anti-fog layer 150 (e.g., an anti-fog treatment or feature, etc.) may be provided as part of the inner surface of first film 122. Anti-fog layer 150 may be a separate layer of material, or may be provided as an integral part of first film 122. Providing an anti-fog surface on first film 122 prevents the formation of water beads or droplets that may otherwise form on first film 122 during heating of food product 112. An anti-fog surface also maintains an aesthetically appealing visual appearance to packaged food product 110 prior to, during, and after heating of packaged food product 110. According to various alternative embodiments, an anti-fog treatment may be provided on one or both of first film 122 and second film 124.

As indicated earlier, one or more vent portions may be provided as part of packaging 114. For example, first film 122 may be provided with perforations 132 to permit a desired amount of steam to escape from the interior of packaging 114 during heating of food product 112 (e.g., along a path indicated by arrow 144 in FIG. 8). Perforations 132 may be provided in any of a variety of shapes, sizes, locations, number and so on to suit a particular food product. Alternatively or in addition, seal portion 126 may provide a self-venting feature for packaging 114, such that one or more portions of seal portion 126 (e.g., the interface between first and second films 122, 124) may be configured to permit a desired amount of steam to escape from the interior of packaging 114 during heating of food product 112 (e.g., along a path indicated by arrow 146 shown in FIG. 8).

In yet other embodiments, packaging 114 may be configured such that a user may “peel back” a portion of first film 122 from second film 124 (e.g., using an “easy peel” feature) to provide an opening through which steam may escape from the interior of packaging 114 during heating of food product 112. For example, due to the presence of paper fibers in the films, the seal may be weakened as the moisture (e.g., steam) escaping from the package reduces the tensile strength of the paper fibers. According to yet further embodiments, one or more vent portions may be configured to provide venting only upon heating of packaged food product 110 (e.g., such that the vent portions are otherwise substantially impermeable to liquids and/or gases).

It should be noted that any of the features shown in the embodiments illustrated in FIGS. 5-8 may be used alone or in any number of combinations with the features shown in the embodiments illustrated in FIGS. 1-4. All such features and combinations of features are to be understood to be within the scope of the present disclosure.

In some embodiments, one or both of the top and bottom films may have a structure different than that disclosed herein. For example, one or more portions of the laminated films may be heat sealed, for example, to provide “channels” or “pathways” that direct moisture along portions of the films and/or to “trap” moisture in desired portions of the films. Other variations in the structure of the films disclosed herein may be made according to various other embodiments.

The various embodiments of the packaged food product disclosed herein provide many benefits to consumers. For example, the packaged food product provides an “on-the-go” food product having user-friendly packaging requiring only a “single step” heating in a microwave oven. Control of steam and moisture content within the packaging during heating decreases preparation time, provides for optimal moisture content of the food product, and ensures an evenly heated food product. Further, the anti-fog treatment of the packaging reduces water droplet formation and maintains an aesthetically pleasing appearance for consumers. Further yet, because the food product may be heated without needing to open the packaging, no additional materials are required (e.g., a napkin, paper towel, etc.), no messes are made within the microwave (e.g., due to spills, splattering, melting, etc. resulting from unpackaged food products or open packagings), and the food product may be eaten right out of the packaging after heating. The creation of a “steam dome” assists in both faster cooking and providing an easy peel feature by weakening the seal through the escape of steam.

It is important to note that the construction and arrangement of the elements of the products and methods as shown in the exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the various embodiments. Accordingly, all such modifications are intended to be included within the scope of the present disclosure as defined in the appended claims. The order or sequence of any process or method steps may be varied or re-sequenced according to alternative embodiments. Other substitutions, modifications, changes, and/or omissions may be made in the design, operating conditions, and arrangement of the exemplary embodiments without departing from the spirit of the present disclosure.

What is claimed is:

1. A packaged food product comprising:
a package comprising:
an inflatable first sheet comprising polymer, and
a generally flat second sheet comprising an absorbent layer, the absorbent layer comprising paper fibers interspersed with polymer fibers;
the first sheet and the second sheet being bonded together to form a non-hermetic peripheral seal comprising: the polymer from the first sheet, the polymer fibers from the second sheet, and the paper fibers from the second sheet, the polymer from the inflatable first sheet being directly bonded to the polymer fibers from the second sheet, the paper fibers weakening the bond between the first sheet polymer and the second sheet polymer fibers, wherein the second sheet is configured to wick moisture into the peripheral seal to degrade the peripheral seal;
an anti-fog layer on an inner surface of the first sheet facing the food product, the anti-fog layer causing moisture that forms on the inner surface of the inflatable first sheet during heating to move toward the absorbent layer; and
food disposed on the second sheet and in direct physical contact with the paper material, wherein the package forms a space around and above the food to permit moisture to uniformly re-enter the food when the package is heated.

2. The packaged food product of claim 1, wherein the food is frozen, and the food is in fluid communication with ambient environment through the non-hermetic seal.

3. The packaged food product of claim 2, wherein the second sheet has a substantially constant thickness across its entire surface area and the paper fibers are cellulose such that the absorbent layer comprises a mixture of paper fibers and polymer fibers.

4. The packaged food product of claim 2, wherein an amount of the paper fibers in the absorbent layer in the peripheral seal varies across the absorbent layer in the peripheral seal to vary the strength of the peripheral seal.

5. The packaged food product of claim 1, wherein the first sheet defines a cover, the cover being in contact with the food prior to heating.

6. The packaged food product of claim 5, wherein the first sheet consists of a flexible film wrapped over and on the food.

7. The packaged food product of claim 6, wherein the second sheet is a flexible film and the cover is dome-shaped.

8. The packaged food product of claim 5, wherein:
the cover is a flexible film wrapped against a top of the food and sides of the food; and
the food is disposed between the cover of the first sheet and the second sheet.

9. The packaged food product of claim 1, wherein:
the non-hermetic peripheral seal comprises a first portion and a second portion; and
the first sheet and the second sheet cooperate to define a closed perimeter area surrounding the food, the closed perimeter area being inset with respect to at least two outermost edges of the absorbent layer.

10. The packaged food product of claim 9, wherein the first portion of the peripheral seal is weaker than the second portion of the peripheral seal.

11. The packaged food product of claim 10, wherein the first portion is weaker than the second portion by virtue of the first portion having a higher amount of paper fibers than the second portion.

12. The packaged food product of claim 1, wherein the second sheet comprises one or more generally flat planar layers and the absorbent layer.

13. The packaged food product of claim 1, wherein the food comprises:
a circular bottom bread resting on the second sheet;
a circular top bread; and
a circular meat disposed between the bottom bread and the top bread.

14. The packaged food product of claim 1, wherein:
the food comprises a stack of circular food components including a circular bread component and a circular meat component;
the first sheet is wrapped against sides and a top of the stack; and
a bottom of the stack rests directly on the second sheet.

15. A packaged food product comprising:
food disposed within a chamber; and
a non-hermetic peripheral seal comprising:
polymer from a first sheet;
paper fibers from an absorbent layer of a second sheet; and
polymer fibers from the absorbent layer of the second sheet, wherein:
the non-hermetic peripheral seal is disposed between the chamber and ambient such that the food is in fluid communication, through the non-hermetic peripheral seal, with ambient environment;
the first sheet comprises an anti-fog layer on an inner surface facing the food product, the anti-fog layer causing moisture that forms on the inner surface of the first sheet during heating to move toward the absorbent layer;
the second sheet is configured to wick moisture into the peripheral seal to degrade the peripheral seal; and
the first sheet is inflatable and configured to form a space around and above the food to permit moisture to uniformly re-enter the food when the packaged food product is heated.

16. The packaged food product of claim 15, wherein the peripheral seal surrounds at least a portion of the food, the food being frozen.

17. The packaged food product of claim 15, wherein the food is formed as a stack of circular food components including at least one bread component and at least one meat component.

18. The packaged food product of claim 16, wherein the non-hermetic seal is a first non-hermetic seal, the packaged food product comprising:
an inflatable polymer cover contacting a top and a side of the stack; and
a second non-hermetic seal disposed radially outward of the first non-hermetic seal such that the frozen food is in fluid communication, with ambient environment, via a pathway defined through both the first non-hermetic seal and the second non-hermetic seal.

19. The packaged food product of claim 15, wherein the wicking of moisture into the peripheral seal by the second sheet consists of directing moisture to the first portion of the peripheral seal using one or more flutes in the first sheet.

20. The packaged food product of claim 15, wherein the space around the food forms a steam dome.
